(19) United States
(12) Patent Application Publication
(10) Pub. No.: US 2007/0184808 A1
(43) Pub. Date: Aug. 9, 2007

(54) Method and device for transmitting speech signals via a data telecommunications network

(75) Inventors: Alberto Canella, Villach (AT); Christian Jenkner, Velden (AT); David Schwingshackl, Villach (AT)

Correspondence Address: Maginot, Moore & Beck LLP;Chase Tower, Suite 3250, 111 Monument Circle, Indianapolis, IN, 46204-5109, US

(73) Assignee: Infineon Technologies AG, Munchen (DE)

(21) Appl. No.: 10/884,800

(22) Filed: Jul. 2, 2004

(30) Foreign Application Priority Data
Jul. 4, 2003 (DE) 103 30 286.7

(51) Int. Cl. H04B 1/04; H04B 1/26

(52) U.S. Cl. 455/313; 455/118

(57) ABSTRACT

In the case of a device for transmission of telephone signals via a data telecommunications network (2) the analogue signals of a telephone terminal are converted to digital signals for transmission via the data telecommunications network (2) and/or, vice versa, digital signals from the data telecommunications network (2) are converted to analogue signals for transmission via the telephone terminal. In order to monitor the operation of the device, advantageously digital signals arising within the device are analyzed. According to the invention a digital signal is acquired within the device and the characteristics of this, which characterize the amplitude and/or the frequency response of the acquired digital signal, are determined. The determined characteristics are sent out via the data telecommunications network (2). In this way the function of such conversion devices can also be monitored over a greater distance via the data telecommunications network (2) and signals arising therein can be analyzed. Advantageously for this purpose the acquired digital signal is filtered by means of a programmable filter (16) and integrated after absolute value generation or squaring. Various measured quantities, such as for example the effective value of the acquired digital signal, can be evaluated based on the frequency response adjusted with the filter (16) and on the result of the integration.

The following invention relates to a method for analyzing signals in a device for the bi-directional conversion between analogue speech signals of a telephone terminal and digital speech signals for transmission via a data telecommunications network, as well as a device designed for implementing the method.

Devices with which telephony or fax signals can be transmitted via a data telecommunications network are known. These devices are inserted between the data telecommunications network and a telephone terminal and/or a fax machine and convert analogue signals of the telephone terminal into digital signals for transmission via the data telecommunications network and, vice versa, digital signals from the data telecommunications network into analogue signals for transmission by means of the telephone terminal. The same applies to fax signals.

Such converter units necessarily therefore have at their disposal devices for D/A conversion and/or A/D conversion. In addition such converter units are usually de-centrally arranged, since the telephones, which as a rule are located in numerous and widespread places, must be connected to them. For analysis of the functional mode of the conversion units it is therefore advantageous if signals arising within the device can be analyzed with as little effort as possible.

The object of the present invention is to create a method and/or a device of the type specified above, whereby digital signals arising in the device can be acquired and analyzed with as little effort as possible.

This object is achieved according to the invention by a method with the features of claim 1 and/or by a device with the features of claim 13. The dependent claims in each case define preferred and advantageous embodiments of the present invention.

According to the invention the device is equipped with a data processing apparatus which can detect or acquire digital signals within the device and determine or evaluate characteristics of these, whereby the evaluated characteristics can be transmitted via the telecommunications network. This has the advantage that signals in interfaces de-centrally arranged between analogue telephone terminals and the data telecommunications network can be monitored per remote diagnostics. Since A/D converters are contained in the interfaces anyway, nearly all signals are also present in digital form, so that the device can be almost entirely monitored by evaluation of the digital signals.

Preferably a processor or a signal processor which is contained in the device for signal processing anyway, is used as the data processing apparatus. Therefore only additional programming must be provided in order to enable the processor to implement the method according to the invention. In this case the processor can carry out the analysis of the digital signal during normal operation or however in special phases, when it needs in particular to make less computational power available for other tasks. In the latter case the method according to the invention can also be implemented in devices where an existing data processing apparatus is already working at full capacity as a result of the regular requirement.

The analysis of signals within the device can therefore be activated from outside by sending corresponding instructions to the device in particular via the telecommunications network. Furthermore the device can also be designed so that it independently carries out the analysis of the signals in regular intervals, at fixed time points or on reaching certain conditions, and transmits the results of the analysis and/or the determined characteristics via the telecommunication network.

The analyzed signals can in principle all be digital signals which arise in the device. In particular the signals within the device which carry the speech data to be transmitted, are acquired and analyzed. Moreover signals, which are connected with the transmission, but do not themselves carry the speech signals, such as for example echo compensation signals, can be analyzed.

The determined characteristics can for example be the dynamic range, the noise or the signal-to-noise ratio. Furthermore spectral components in various frequency ranges can also be determined.

Normal methods of signal processing and/or analysis can be used to determine the characteristics, as for example in the case of spectrographic analysis.

Advantageously however a single value, which has been obtained in a more simple way, is used as a characteristic to describe the determined digital signal. For this purpose an integrator, which is integrated over a certain length of time and the end result of which is used as a characteristic, can be employed. In addition the average of several in particular time-consecutive values of the digital signal can also be used. Use of a peak value is also conceivable. The use of an integrator has the advantage that very small signals can also be analyzed, since the individual values are cumulated through the integration. In each case the integration time can be increased, in order to achieve a higher end result.

In order for example to be able to assign the characteristic determined through integration to certain properties of the analyzed digital signal, advantageously it can be arranged that the analyzed signal is processed in a defined manner before integration. In this case the processing takes place in accordance with fixed processing rules, which can comprise digital filtering and/or amplification for example. At the same time the processing may also comprise formation of the square or absolute value generation. In this way characteristics which characterize different properties of the analyzed digital signal can be determined by suitable adaptation of the processing rules and subsequent integration.

Absolute value generation basically corresponds to full-wave rectification, so that an average value can be obtained as a result of the subsequent integration. If the signal is squared before the integration, the effective value can be computed in this way. Apart from this the digital signal can also be integrated without absolute value generation or squaring, whereby equal components in the digital signal can be acquired in this way. Also small digital signals may be analyzed with sufficient accuracy and/or resolution through the possible previous use of amplification. In this case an amplifier with variable amplification may be employed or it is possible to use an amplifier with fixed amplification, which can be manipulated by means of a change-over switch, so that two different amplifications may be set, that is to say 1 and the fixed amplification of the amplifier.

An essential tool for analysis is also formed by the adjustable filter, with which the analysis can be purposefully carried out in different frequency ranges. For example the function of a band-pass filter can be varied, so that for example the effective value or the average value can be determined in a certain frequency range. This band-pass filter can be adjusted, in order that the signal components can be determined in different frequency ranges, so that spectral analysis is finally possible with minimum effort.

Using said method, the characteristics can be evaluated with a very low computational effort. The type of the evaluated characteristics is limited by the processing rules employed, however in practice anyway only selected characteristics are of interest. Therefore the adaptable processing rules must be selected in such a manner that the interesting characteristics can be evaluated.

The invention is described below in detail on the basis a preferred embodiment with reference to the attached drawing.

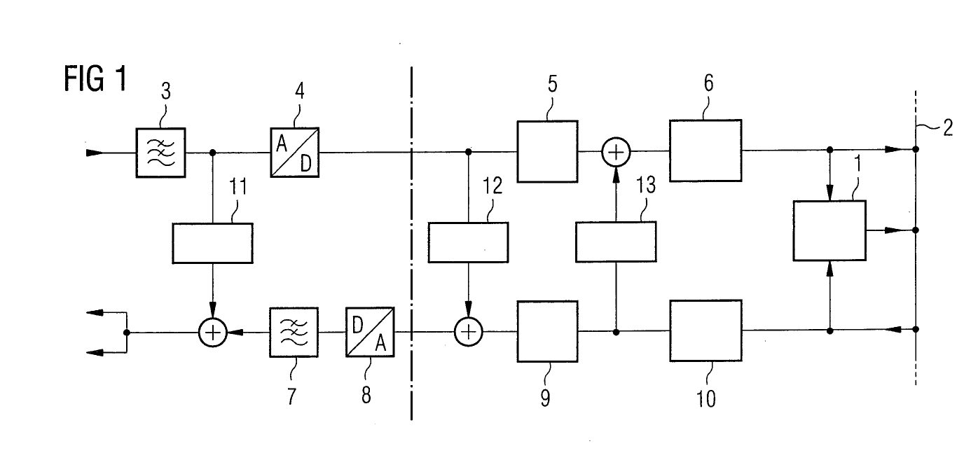

FIG. 1 shows the architecture of a switching arrangement for connecting an analogue telephone to a data telecommunications line, and

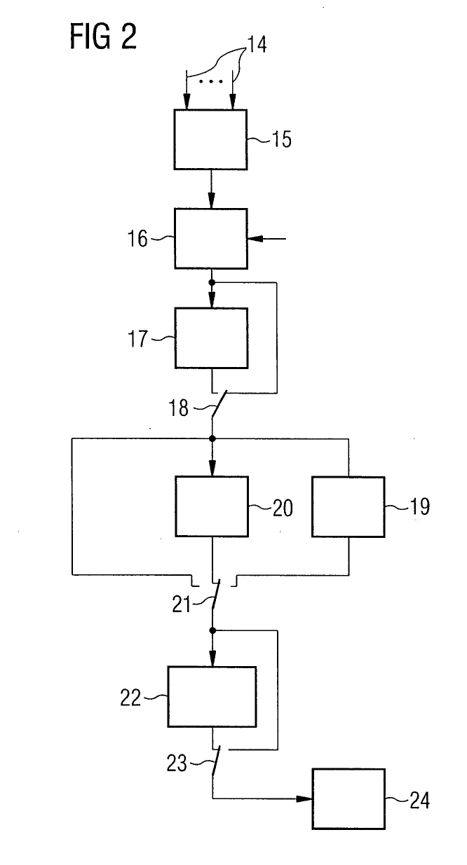

FIG. 2 shows the schematic structure of an apparatus for analyzing digital signals within the device in accordance with FIG. 1.

The switching arrangement illustrated in FIG. 1 serves to connect an analogue telephone to a data telecommunications line 2. The service made available thereby is also called Voice Over IP, if the telephony data are transmitted via the data telecommunications network 2 according to the IP protocol. In the case of the configuration illustrated in FIG. 1a transmission path appears at the top from left to right and a receiver path at the bottom from right to left. A low-pass filter 3, to which an A/D converter 4 is connected, is located on the input in the transmission path at the top. A digital transmission amplifier 5 with a downstream filter 6 is connected to the A/D converter 5. The output of the filter 6 is connected to the data telecommunications line 2, which is part of a data telecommunications network. In FIG. 1 the analogue part is divided from the digital part by a dotted line.

In the case of the receiver path a filter 10 with a downstream amplifier 9 is connected to the data telecommunications line 2. The output of the amplifier 9 leads to a D/A converter 8, to which a low-pass filter 7 is connected, which leads to the analogue telephone.

In addition there are provided two impedance adapters 11, 12, which adjust the impedance on the input side and on the output side in such a manner that the signal component transmitted to the telephone and/or the signal component received from the telephone becomes maximum.

Furthermore a filter 13, which leads from the receiver path to the transmission path, is provided.

The present invention is implemented in the transmission measuring set 1, which is connected both to the data telecommunications line 2 and also to the parts of the receiver path and/or the transmission path, which directly join the data telecommunications line 2. Moreover additional connections to other nodal points on the digital side of the circuit illustrated in FIG. 1 are provided, which however are not illustrated. These lines not illustrated serve to analyze digital signals arising within the circuit by means of the transmission measuring set 1.

The transmission measuring set 1 represents a functional block of digitally implemented functions, which can be implemented either in a separate data processing apparatus and/or in a separate processor or also in a processor, which is used for other tasks, such as the digital filters 6 and 10 for example.

The functional blocks belonging to the transmission measuring set 1 are schematically illustrated in FIG. 2. The digital signals to be analyzed have the reference numeral 14 and represent different signals arising within the circuit, which are to be analyzed by means of the present invention. A signal to be analyzed is selected from the signals 14 by means of a multiplexer 15 and fed to an adjustable digital filter 16. An amplifier 17 with programmable amplification is connected to the output of the filter 16. A change-over switch 18, which can pass on either the output signal of the amplifier 17 or the input signal of the amplifier 17, is connected to the output of the amplifier 17. In this way the amplifier 17 can be bridged and/or the amplification can be switched between 1 and 64 by means of the change-over switch 18.

The output signal of the change-over switch 8 [sic] is branched three ways. One way leads directly to a change-over switch 21, the second way via a squaring device 20 to the change-over switch 21 and the third way via an absolute value generator 19 to the change-over switch 21. Therefore the signal to be analyzed without further change, the absolute value of the signal to be analyzed or the square of the signal to be analyzed can be selected and passed on with the aid of the change-over switch 21.

The selected signal leads further to an integrator 22, to which a change-over switch 23 is connected, so that the integrator 22 can be bridged. The change-over switch 23 is finally connected to the measurement recorder 24 in which the end result is stored and can be read out.

With the configuration illustrated in FIG. 2 various measurements are possible. Firstly different frequency ranges, in which the characteristics are to be determined, can be selected by suitable programming of the filter 16.

Furthermore the amplification can be adjusted by means of the change-over switch 18 in such a manner that an optimum range of values for measurement arises. In order to measure the effective value the change-over switch 21 is adjusted in such a manner that the signal is passed on in square form. The squared signal is integrated over a certain length of time, in order to evaluate the effective value of the signal. The measurement result therefore represents the integrated square of the signal, so that the root still has to be drawn. In this case the length of time over which the squared signal is integrated and how many measured values of the time-discrete digital signal have appeared during this integration time must also be taken into consideration.

Likewise the absolute value generator 19, with which the effective value however can only be evaluated if the curve shape is known, can be used. In the case of a sinusoidal signal the average value measured by means of the absolute value generator 19 still has to be multiplied by n and divided by 2×√2 , in order to arrive at the effective value. When comparing the results using the squaring device 20 and/or using the absolute value generator 19 conclusions can also be drawn with regard to the curve shape and/or to what extent the analyzed signal deviates from the sine form.

With the aid of the present invention both sinusoidal and non-sinusoidal signals can be acquired. Furthermore signals with a very small amplitude can also be analyzed. Advantageously the insertable amplifier 17 is only used if the output signal of the squaring device 20 is consulted. With the aid of the programmable filter 16 any arbitrary filter form can be selected. Furthermore equal components and/or direct voltages can in principle also be measured with the present invention.

1-14. (canceled)

15. A method for analyzing signals in a device for the bidirectional conversion between analogue speech signals of a telephone terminal and digital speech signals for transmission via a data telecommunications network, the method comprising:
a. providing a switching arrangement to connect the telephone terminal to the data telecommunications network, the switching arrangement comprising
i. an A/D converter;
ii a D/A converter; and
iii. a digital data processing apparatus;
b. detecting a digital signal arising within the switching arrangement using the digital data processing apparatus;
c. determining characteristics of the detected digital signal using the digital data processing apparatus, said characteristics characterizing properties of the detected digital signal including the amplitude or the time progression of the detected digital signal; and
d. transmitting the characteristics of the detected digital signal via the data telecommunications network.

16. The method according to claim 15 wherein the detected digital signal is selected by a multiplexer.

17. The method according to claim 15 wherein the detected digital signal is processed before determination of the characteristics as a function of pre-definable processing rules concerning the amplitude or the time progression.

18. The method according to claim 17 wherein the pre-definable processing rules are fed to the switching arrangement via the data telecommunications network.

19. The method according to claim 17 wherein processing of the detected digital signal comprises filtering with an adjustable filter.

20. The method according to claim 19 wherein the adjustable filter is a programmable band-pass filter, a programmable notch filter, a programmable low-pass filter or a programmable high-pass filter.

21. The method according to claim 17 wherein processing of the detected digital signal comprises amplification by means of an adjustable amplifier.

22. The method according to claim 17 wherein processing of the detected digital signal comprises squaring of the digital signal.

23. The method according to claim 17 wherein processing of the detected digital signal comprises forming the absolute value of the digital signal.

24. The method according to claim 17 wherein processing of the detected digital signal comprises temporal integration.

25. The method according to claim 15 wherein the characteristics of the detected digital signal are determined by digital spectrographic analysis.

26. The method according to claim 15 wherein the characteristics of the detected digital signal describe the noise, the signal-to-noise ratio or the dynamics of the digital signal.

27. A device for the bi-directional conversion between analogue speech signals of a telephone terminal and digital speech signals for transmission via a data telecommunications network, the device comprising:
a. an A/D converter;
b. a D/A converter; and
c. a digital data processor connected to the data telecommunications network, the digital data processor operable to detect a digital signal arising within the device and determine the characteristics of the digital signal, said characteristics characterizing properties of the digital signal including the amplitude or time progression of the digital signal, the digital data processing apparatus further operable to transmit the characteristics via the data telecommunications network.

28. The device of claim 27 further comprising a multiplexer, wherein the detected digital signal is selected by the multiplexer.

29. The device of claim 27 wherein the digital data processor is operable to process the digital signal before determination of the characteristics of the digital signal as a function of pre-definable processing rules concerning the amplitude or the time progression.

30. The device of claim 29 wherein the digital data processor is operable to receive the pre-definable processing rules via the data telecommunications network.

31. The device of claim 29 wherein the digital data processor is operable to process the digital signal by filtering with an adjustable filter.

32. The device of claim 31 wherein the adjustable filter is a programmable band-pass filter, a programmable notch filter, a programmable low-pass filter or a programmable high-pass filter.

33. The device of claim 27 wherein the digital data processor is operable to determine the characteristics of the digital signal by digital spectrographic analysis.

34. The device of claim 27 wherein the characteristics of the detected digital signal describe the noise, the signal-to-noise ratio or the dynamics of the digital signal.
